(19) United States
(12) Patent Application Publication
(10) Pub. No.: US 2015/0221462 A1
(43) Pub. Date: Aug. 6, 2015

(54) ROTARY SWICH MECHANISM

(71) Applicant: CHING-HSIUNG CHU, TAIPEI (TW)

(72) Inventor: CHING-HSIUNG CHU, TAIPEI (TW)

(21) Appl. No.: 14/172,920

(22) Filed: Feb. 5, 2014

(51) Int. Cl. H01H 19/54; H01H 19/02

(52) U.S. Cl. CPC H01H 19/54; H01H 19/025; H01H 2219/036

(57) ABSTRACT

A rotary switch includes a base seat having a shaft, a round track portion, a resilient element, a rotary element pivotally mounted onto the shaft, a contact element, a plurality of conductive terminals, a cover, and a circuit module. The base seat has a restraining portion where the resilient element is disposed therein. The rotary element is formed with an interference teeth portion. The contact element and the interference teeth portion are capable of rotating in conjunction with the rotary element whereby enabling a plurality of contact arms of the contact element to electrically contact the plurality of conductive terminals. The resilient element is deformed and stretching backwards in conjunction with rotation of the rotary element, and returns to an original position to engage with the interference teeth portion when the rotary element rotates in position.

### BACKGROUND OF THE INVENTION

1. Field of the Invention

The present invention relates to a switch mechanism, and more particularly to a rotary switch mechanism having a mechanical structure and being capable of generating different coding signals by continuous rotation thereof.

2. Related Art

Generally, a rotary switch is often provided for 3C electronic products, communication devices, or home appliance. The rotary switch is intended to switch a power supply and to adjust the volume of the power supply of an application product so as to modulate operation speed, power, or other functions thereof, for example, rotational speed of a fan, temperature of an air conditioner, volume of a radio, brightness of a light, and a signal strength of a wireless radio.

As is well known that a traditional mechanical switch includes a main body and a rotary element pivotally installed in the main body for rotating, wherein rotation of the rotary element is positioned by a metal elastic plate propping against the rotary element. However, the metal elastic plate is a cantilever structure which tends to become elastic fatigue after use for a certain time and thus enables an ineffective engagement of the metal elastic plate and the rotary element. Besides, one end of the cantilever elastic plate is generally soldered to the main body or fixedly in the main body, another end of the cantilever elastic plate props against the rotary element. Due to repeatedly bending of the cantilever elastic plate, the cantilever elastic plate tends to come off from the main body or to be deformed. Furthermore, differing from a dip switch or a knife switch, a rotary switch is mainly intended to provide multistage switches along a rotation path to control an application product, such as controlling brightness or volume. However, a traditional mechanical rotary switch only is only capable of providing a limited number of stages for switching. In other words, for a cycle of 360 degrees of a rotation, the traditional mechanical rotary switch is merely allowed to rotate with one cycle for controlling functions of an application product, and a continuous rotation cannot provide further switches for controlling the application product, and thus the application product is not possible to perform perfectly.

### SUMMARY OF THE INVENTION

An object of the present invention is to provide a rotary switch mechanism having a simple structure and capable of being precisely rotated in place.

Another object of the present invention is to provide a rotary switch mechanism being capable of continuously rotating to generate different coding signals.

To achieve the above objects, the rotary switch mechanism of the present invention includes abase seat comprising a shaft, at least a restraining portion, and a round track portion, the shaft and the restraining portion respectively extending upwards out of a surface of the base seat and spaced apart from each other, and the round track portion disposed around the shaft between the shaft and the restraining portion; a rotary element pivotally mounted onto the shaft, an interference teeth portion formed on a periphery of the rotary element above the round track portion; a resilient element of which one end is connected to the restraining portion, and another end of the resilient element extending out of the restraining portion and resiliently engaging with the interference teeth portion; a cover covering the interference teeth portion and the restraining portion; a plurality of conductive terminals disposed under and around the base seat, one end of each of the conductive terminals extending out of the base seat to form a soldering portion; a contact element mounted to a bottom of the rotary element between the plurality of conductive terminals and the base seat, the contact element comprising a plurality of contact arms for electrically connecting the plurality of conductive terminals; and a circuit module disposed below the base seat and electrically connected with the plurality of conductive terminals where the plurality of conductive terminals penetrate the circuit module, the circuit module at least comprising a base plate and multiple pins, and the multiple pins extending out of the base plate so as to electrically contact a circuit board.

In accordance with an embodiment of the present invention, the resilient element comprises a spring and an engaging head, one end of the spring fixed in the restraining portion of the base seat, another end of the spring propping against the engaging head, the engaging head intended to be engageable with the interference teeth portion, the interference teeth portion having multiple tooth faces and tooth grooves arranged at a same plane, the engaging head being depressable to move towards an inner portion of the restraining portion in conjunction with the rotation of the interference teeth portion, and when the rotary element rotates in place, the spring props the engaging head against one of the tooth grooves.

In accordance with another embodiment of the present invention, the signals are coded in a format of pulse width modulation (PWM) for activating the power supply or/and increasingly boosting a power supply of an external power source, or the signals being coded are intended to increasingly lower or deactivate the power supply.

In accordance with another embodiment of the present invention, the rotary element further comprises a position indicating portion formed on one end of the rotary element opposite to the interference teeth portion for indicating a position where the rotary element is being rotated.

With the above-mentioned structure, the rotary element is pivotally rotatable about the shaft along the round track portion, and the contact element and the interference teeth portion being capable of rotating in conjunction with the rotary element whereby enabling the plurality of contact arms of the contact element to electrically contact the plurality of conductive terminals along the round track portion so as to generate electrical signals which are then being transmitted to the circuit module for coding signals, the resilient element being deformed and stretching backwards in conjunction with rotation of the interference teeth portion, and the resilient element returns to an original position to engage with the interference teeth portion when the rotary element rotates in position.

Accordingly, the rotary switch mechanism of the present invention utilizes the engagement of the resilient element and the interference teeth portion of the rotary element to position the rotation of the rotary element, and utilizes the circuit module to divide the maximum power supply into the plurality of segment values and generate a coding signal according to each position of the rotation of the rotary element that corresponds to a respective segment value. Therefore, the rotary switch mechanism is capable of reaching each one of the plurality of segment values by continuously rotating several cycles and not tends to be broken. Furthermore, the plurality of segment values of the power supply enables a decent performance of an application product, whereby overcoming drawbacks of a traditional switch that is only capable of providing a limited number of switches and a poor performance.

### BRIEF DESCRIPTION OF THE DRAWINGS

FIG. 1 is a perspective exploded view of a rotary switch mechanism of the present invention;

FIG. 2 is a perspective assembly view of FIG. 1;

FIG. 3 is a schematic top plan view showing an engagement of a resilient element and an interference teeth portion of the present invention;

FIG. 4 is a schematic top plan view showing the resilient element that engages with the interference teeth portion when a rotary element of the present invention rotates in place;

FIG. 5 is a right elevational view of FIG. 2; and

FIG. 6 is schematic view showing a depressable device of the present invention being depressed.

### DESCRIPTION OF THE PREFERRED EMBODIMENTS

A rotary switch mechanism 1 of the present invention is applicable to electronic products, electric appliances or lighting devices for switching on or switching off or for controlling other functions thereof, such as, adjusting brightness of a light device, volume, wind velocity (e.g. a fan), or fire power (e.g. a gas stove) so as to precisely control an application product by multistage switches.

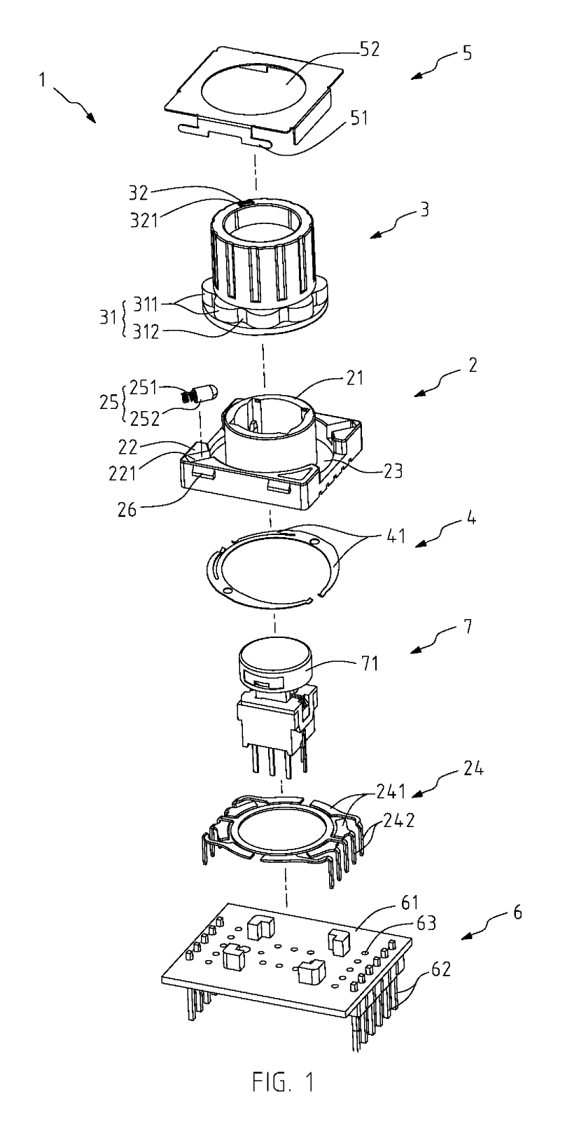

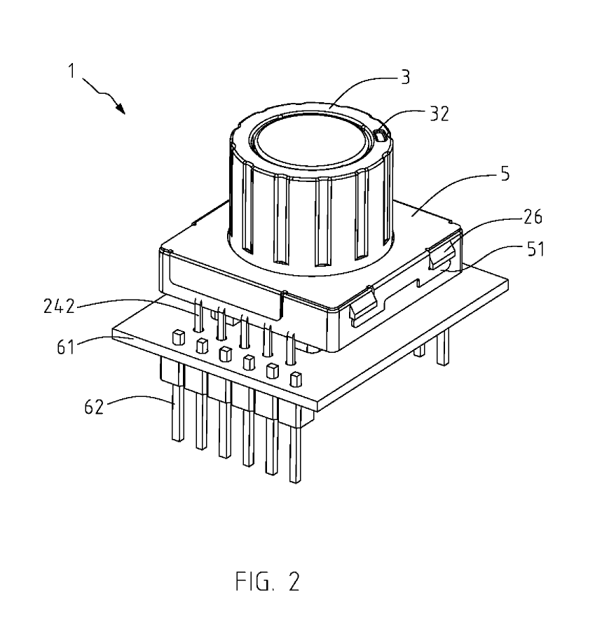

Referring to FIGS. 1 and 2 illustrating a preferable embodiment of the present invention, the rotary switch mechanism 1 of the present invention comprises abase seat 2, a resilient element 25, a rotary element 3, a contact element 4, a cover 5 and a circuit module 6. The base seat comprises a shaft 21, at least a restraining portion 22, and a round track portion 23. The shaft 21 has a round tubular shape and is hollow therein from a top to a bottom thereof. The shaft 21 and the restraining portion 22 respectively extend upwards out of a surface of the base seat 2 and spaced apart from each other. The round track portion 23 is disposed around the shaft 21 between the shaft 21 and the restraining portion 22, wherein the restraining portion 22 is disposed at a corner of the base seat 2 and has a restraining slot 221 formed in the restraining portion 22. One end of the restraining slot 221 communicates with the round track portion 23, and the restraining slot 221 is open widely at a top thereof for installation of the resilient element 25. Furthermore, two opposite sides of the base seat 2 are respectively provided with a protruding block 26, and two opposite sides of the cover 5 are respectively provided with a fastening portion 51 for fastening the protruding block 26.

The rotary element 3 is pivotally mounted onto the shaft 21. An interference teeth portion 31 is formed on a periphery of a bottom of the rotary element 3 above the round track portion 23. The interference teeth portion 31 has multiple tooth faces 311 and tooth grooves 312 formed between each two adjacent tooth faces 311. In the preferable embodiment, the multiple tooth faces 311 and the tooth grooves 312 cooperatively form a continuously curved face and are arranged on a same plane for facilitating the interference engagement with the resilient element 25. The rotary element 3 is located on the round track portion 23 and is pivotally rotatable about the shaft 21 along the round track portion 23 in a clockwise direction or a counterclockwise direction.

As shown in FIG. 1, a plurality of conductive terminals 24 are disposed under and around the base seat 2. One end of each of the conductive terminals 24 extends out of the base seat 2 to form a soldering portion 242 which penetrates the circuit module 6 and extends perpendicularly to be soldered to a circuit board (not shown). Another end of each conductive terminal 24 is exposed to the round track portion 23 to form a contact portion 241. The contact element 4 is mounted to a bottom of the rotary element 3 between the plurality of conductive terminals 24 and the base seat 2. The contact element 4, made of metal, comprises a plurality of contact arms 41 and has a ring shape, wherein one end of each of the contact arms 41 is inclined so as to contact the contact portions 241 of the plurality of conductive terminals 4.

As shown in FIGS. 1 and 2, the cover 5 is made of metal and is formed with a mounting hole 52 that is mounted to the rotary element 3 in an upper direction of the base seat to a lower direction thereof for covering the interference teeth portion 31, the restraining portion 22, and the base seat 2. Each of the fastening portions 51 extends downwards and bends to form an L shape so as to fasten the respective protruding block 26.

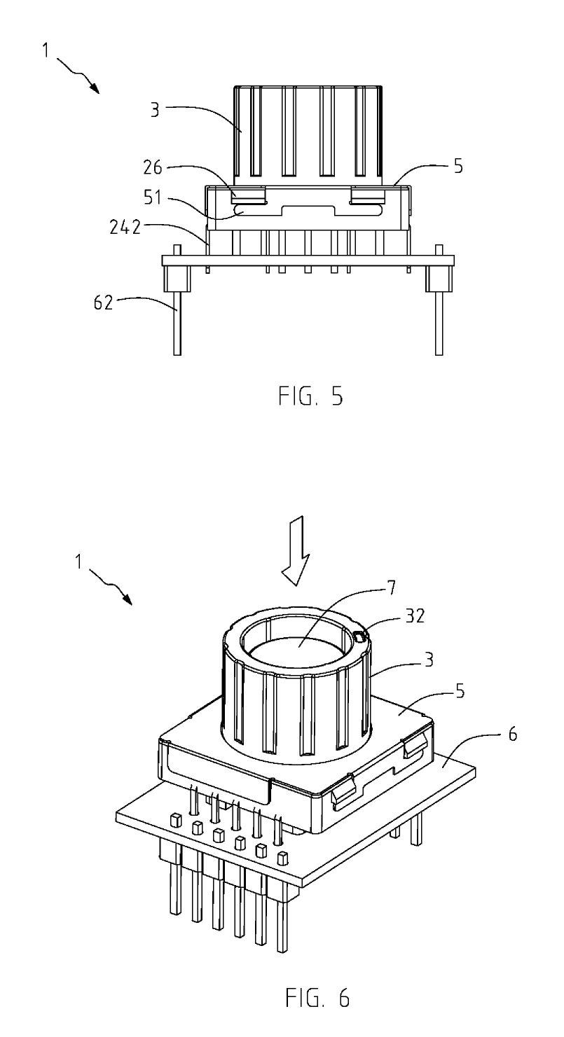

The circuit module 6 at least comprises a base plate 61, multiple pins 62, multiple through holes 63, and is integrated with a control circuit, wherein the multiple pins 62 extend out of the base plate 61 so as to electrically contact the circuit board. In assembly, the circuit board 6 is disposed under the base seat 2, with the multiple through holes 63 pass through the soldering portions 242 the plurality of conductive terminals 24 (as shown in FIG. 5).

The rotary switch mechanism 1 of the present invention is advantageous over a traditional mechanical rotary switch that the circuit module 6 is utilized to accept a predetermined maximum power supply which is capable of being divided into a plurality of segment values by the control circuit. For example, if an application product is an electronic lighting device (not shown) capable of operating at a maximum power supply of 60 watt, then, based on a practical application, the maximum power supply of 60 watt can be divided into 10 segment values. More specifically, a rotation of one cycle of the rotary switch mechanism 1 is defined to provide switches of 8 stages. Therefore, rotating one and one fourth cycles of the rotary element 3 is capable of reaching the maximum power supply for 10 stages. Accordingly, multistage switches of the rotary switch mechanism 1 enable a decent performance of the electronic lighting device that the brightness can be changed in great gradation or the volume can be adjusted more precisely.

Particularly, the resilient element 25 comprises a spring 251 and an engaging head 252 which is made of metal and has an arc face. One end of the spring 251 is fixed in the restraining portion 221 of the base seat 2, and another end of the spring 251 props the engaging head 252 against the interference teeth portion 31 in a horizontal direction.

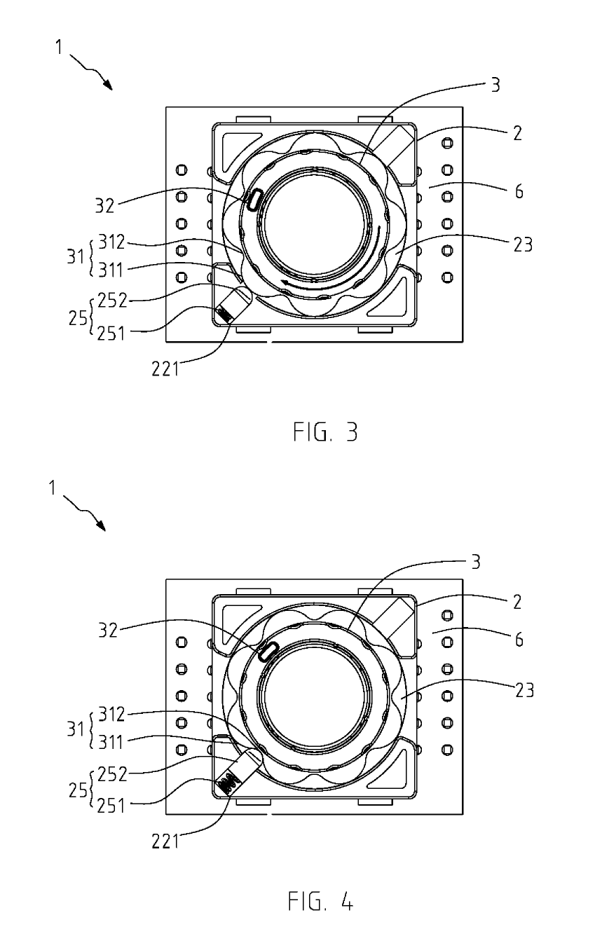

Further referring to FIGS. 3 and 4, the rotary switch mechanism 1 in use, the rotary element 3 is pivotally rotatable about the shaft 21 along the round track portion 23, and the contact element 4 and the interference teeth portion 31 are capable of rotating in conjunction with the rotary element 3 whereby enabling the plurality of contact arms 41 of the contact element 4 to electrically contact the plurality of conductive terminals 24 along the round track portion 23 so as to generate electrical signals which are then being transmitted to the circuit module 6 for coding signals. The resilient element 25 is thus deformed and stretching backwards in conjunction with rotation of the interference teeth portion 31; in other words, the engaging head 252 is constantly engaging with the multiple tooth faces 311 and tooth grooves 312 as the rotation of the interference teeth portion 31, where the spring 251 is being depressed to move towards an inner portion of the restraining slot 221. When the rotary element 3 rotates in position, the spring 251 props the engaging head 252 against one of the tooth grooves 312 of the interference teeth portion 31 at an original position.

As described above, the rotation of the rotary element 3 at each one of the tooth grooves 312 represents one of the segment values being reached. In a practical application, a clockwise rotation of the rotary element is defined to boost a power supply, while a counterclockwise rotation is defined to lower a power supply, wherein the rotary element 3 is capable of continuously rotating multiple cycles to reach either one of the plurality of segment values.

Furthermore, the signals coded by the circuit module 6 is in a format of pulse width modulation (PWM) for activating the power supply or/and increasingly boosting a power supply of an external power source, or the signals being coded are intended to increasingly lower or deactivate the power supply. As a result, the rotary switch mechanism 1 is capable of controlling an application product more precisely than a traditional mechanical rotary switch.

Referring to FIG. 6, the rotary switch mechanism of the present invention further comprises a depressable device 7 installed in the hollow shaft 21 of the base seat 2. The depressable device 7 comprises a first light emitting diode (LED) 71 which is lighted by depressing the depressable device 7 so as to allow a user to easily and quickly know a state of switching on or switching off of the rotary switch mechanism 1. On the other hand, the first LED 71 is capable of lighting in different brightness when the rotary element 3 rotates at different positions. The first LED 71 has a transparent case which is made of different material than the rotary element 3 and is being processed by printing or laser engraving. In a different extent that the first LED 71 is exposed to the rotary element 3, the first LED 71 performs various lighting effects. Furthermore, the depressable device 7 is adhesive dripped with the base seat 2 after being installed in the shaft 2, that is, the depressable device 7 is additionally provided in customization or the depressable device 7 is optionally taken out in another embodiment.

In particular, in order for a user to easily and clearly recognize a position where the rotary element 3 is being rotated, the rotary element 3 further comprises a position indicating portion 32 formed on one end of the rotary element 3 opposite to the interference teeth portion 31. In a practical use, the position indicating portion 32 is coated with reflective paint for explicitly indication. Alternatively, the position indicating portion 32 is installed with a second LED 321 which is lighting along the rotation of the rotary element 3 and is lighting in different colors for distinguishing clockwise rotation from counterclockwise rotation.

Accordingly, the rotary switch mechanism 1 of the present invention utilizes the engagement of the resilient element 25 and the interference teeth portion 31 of the rotary element 3 to position the rotation of the rotary element 3, and utilizes the circuit module 6 to divide the maximum power supply into the plurality of segment values and generate a coding signal according to each position of the rotation of the rotary element that corresponds to a respective segment value. Therefore, the rotary switch mechanism 1 is capable of reaching each one of the plurality of segment values by continuously rotating several cycles and not tends to be broken. Furthermore, the plurality of segment values of the power supply enables a decent performance of an application product, whereby overcoming drawbacks of a traditional switch that is only capable of providing a limited number of switches and a poor performance.

It is understood that the invention may be embodied in other forms within the scope of the claims. Thus the present examples and embodiments are to be considered in all respects as illustrative, and not restrictive, of the invention defined by the claims.

What is claimed is:

1. A rotary switch mechanism, comprising:
a base seat comprising a shaft, at least a restraining portion, and a round track portion, the shaft and the restraining portion respectively extending upwards out of a surface of the base seat and spaced apart from each other, and the round track portion disposed around the shaft between the shaft and the restraining portion;
a rotary element pivotally mounted onto the shaft, an interference teeth portion formed on a periphery of the rotary element above the round track portion;
a resilient element of which one end is connected to the restraining portion, and another end of the resilient element extending out of the restraining portion and resiliently engaging with the interference teeth portion;
a cover covering the interference teeth portion and the restraining portion;
a plurality of conductive terminals disposed under and around the base seat, one end of each of the conductive terminals extending out of the base seat to form a soldering portion;
a contact element mounted to a bottom of the rotary element between the plurality of conductive terminals and the base seat, the contact element comprising a plurality of contact arms for electrically connecting the plurality of conductive terminals; and
a circuit module disposed below the base seat and electrically connected with the plurality of conductive terminals where the plurality of conductive terminals penetrate the circuit module, the circuit module at least comprising a base plate and multiple pins, and the multiple pins extending out of the base plate so as to electrically contact a circuit board;
wherein the rotary element is pivotally rotatable about the shaft along the round track portion, and the contact element and the interference teeth portion being capable of rotating in conjunction with the rotary element whereby enabling the plurality of contact arms of the contact element to electrically contact the plurality of conductive terminals along the round track portion so as to generate electrical signals which are then being transmitted to the circuit module for coding signals, the resilient element being deformed and stretching backwards in conjunction with rotation of the interference teeth portion, and the resilient element returns to an original position to engage with the interference teeth portion when the rotary element rotates in position.

2. The rotary switch mechanism of claim 1, wherein the resilient element comprises a spring and an engaging head, one end of the spring fixed in the restraining portion of the base seat, another end of the spring propping against the engaging head, the engaging head intended to be engageable with the interference teeth portion, the interference teeth portion having multiple tooth faces and tooth grooves arranged at a same plane, the engaging head being depressable to move towards an inner portion of the restraining portion in conjunction with the rotation of the interference teeth portion, and when the rotary element rotates in place, the spring props the engaging head against one of the tooth grooves.

3. The rotary switch mechanism of claim 1, wherein the circuit module is capable of receiving a predetermined maximum power supply which is capable of being divided into a plurality of segment values by the circuit module, each of the plurality of segment values is reachable by the rotation of the rotary element, and the rotary element is capable of continuously rotating multiple cycles to reach either one of the plurality of segment values.

4. The rotary switch mechanism of claim 1, wherein the signals are coded in a format of pulse width modulation (PWM) for activating the power supply or/and increasingly boosting a power supply of an external power source, or the signals being coded are intended to increasingly lower or deactivate the power supply.

5. The rotary switch mechanism of claim 1, wherein the restraining portion is disposed at a corner of the base seat, and the resilient element engages with the interference teeth portion of the rotary element in a horizontal direction.

6. The rotary switch mechanism of claim 1, wherein the contact element has a ring shape and is made of metal, and one end of each of the contact arms is inclined so as to contact the plurality of conductive terminals.

7. The rotary switch mechanism of claim 1, wherein the interference teeth portion has multiple tooth faces and tooth grooves that cooperatively form a continuously curved face, and one end of the resilient element has an arc face for facilitating the rotation of the rotary element.

8. The rotary switch mechanism of claim 1, wherein the shaft is hollow inside where a depressable device is installed therein, and the depressable device comprises a first light emitting diode (LED) which is lighted by depressing the depressable device.

9. The rotary switch mechanism of claim 1, wherein the rotary element further comprises a position indicating portion formed on one end of the rotary element opposite to the interference teeth portion for indicating a position where the rotary element is being rotated.

10. The rotary switch mechanism of claim 1, wherein two opposite sides of the base seat are respectively provided with a protruding block, and two opposite sides of the cover are respectively provided with a fastening portion for fastening the protruding block.
